(19) United States
(12) Patent Application Publication
(10) Pub. No.: US 2013/0016047 A1
(43) Pub. Date: Jan. 17, 2013

(54) TOUCH PANEL INTEGRATED DISPLAY DEVICE AND METHOD FOR MANUFACTURING THE SAME

(71) Applicant: Yoshifumi MASUMOTO, Niigata-ken (JP)

(72) Inventor: Yoshifumi MASUMOTO, Niigata-ken (JP)

(73) Assignee: ALPS ELECTRIC CO., LTD., Tokyo (JP)

(21) Appl. No.: 13/402,766

(22) Filed: Feb. 22, 2012

(30) Foreign Application Priority Data
Jul. 15, 2011 (JP) 2011-156712
Jan. 5, 2012 (JP) 2012-000829

(51) Int. Cl. G06F 3/041; B32B 37/12

(52) U.S. Cl. 345/173; 156/60

(57) ABSTRACT

A method for manufacturing a touch panel integrated display device including a touch panel and a display panel that are integrally stacked, with a light-transmissive sticky layer interposed therebetween, includes the steps of (a) forming a transparent conductive layer by transfer onto a display surface of the display panel, with an adhesive layer interposed therebetween, by using a transferable film having the adhesive layer and the transparent conductive layer; (b) stacking a polarizing layer on one surface of the touch panel, the one surface being an input surface of the touch panel; and (c) bonding the transparent conductive layer formed on the display surface of the display panel to the other surface of the touch panel, with the sticky layer interposed therebetween.

### CLAIM OF PRIORITY

This application claims benefit of Japanese Patent Application No. 2011-156712 filed on Jul. 15, 2011 and No. 2012-000829 filed on Jan. 5, 2012, which are hereby incorporated by reference.

### BACKGROUND OF THE INVENTION

1. Field of the Invention

The present invention relates to touch panel integrated display devices and methods for manufacturing the same. In particular, the present invention relates to a touch panel integrated display device and a method for manufacturing the same that can suppress electromagnetic noise from a display panel, reduce the device thickness, and lower the manufacturing costs.

2. Description of the Related Art

In an operation unit of electronic equipment, such as mobile equipment, a display device is often used which includes a touch panel disposed on a display side of a display panel, such as a liquid crystal panel or an organic light-emitting diode (OLED) panel. A touch panel is a light-transmissive input unit which includes electrode layers composed of light-transmissive bases and transparent conductive films. Images displayed on the display panel can be viewed through the touch panel. Thus, the operator can perform an input operation directly on the display panel while viewing images and menus displayed thereon.

Examples of such a display device include one which is formed by integrally stacking a capacitive touch panel and a liquid crystal panel. FIG. 19 is a schematic cross-sectional view of a touch panel integrated display device 101 according to the related art. The touch panel integrated display device 101 illustrated in FIG. 19 includes a capacitive touch panel 110 and a liquid crystal panel 130 that are bonded to each other by a sticky layer 160 therebetween. The touch panel 110 includes a first electrode layer 112 and a second electrode layer 116. By touching a surface of the touch panel 110 with a finger or the like in an input operation, a capacitance is formed between the finger and the electrode layers 112 and 116. The change in capacitance allows detection of input position information. A touch panel integrated display device having such a configuration is disclosed, for example, in Japanese Unexamined Patent Application Publication No. 2010-231186.

In the touch panel integrated display device 101 illustrated in FIG. 19, various types of electromagnetic noise from the liquid crystal panel 130 may be detected by the first electrode layer 112 or the second electrode layer 116 of the touch panel 110. In this case, electromagnetic noise from the liquid crystal panel 130 may become background noise during an input operation and degrade the signal-to-noise (S/N) ratio, or even cause malfunction of the touch panel 110.

Examples of a method that can reduce the effect of electromagnetic noise from the liquid crystal panel 130 include a method which involves providing a predetermined distance between the liquid crystal panel 130 and the touch panel 110, and a method which involves placing a shielding member, such as a transparent conductive layer-attached film, between the liquid crystal panel 130 and the touch panel 110. For example, Japanese Unexamined Patent Application Publication No. 2008-262326 discloses a configuration of a display panel and a touch panel which includes void portions.

As a way of blocking electromagnetic noise from a display panel, Japanese Unexamined Patent Application Publication No. 2010-86498 discloses a method which involves providing a transparent conductive layer on a side of a touch panel adjacent to a display panel.

To suppress the effect of electromagnetic noise, however, it is necessary that the display panel and the touch panel be spaced apart by a distance of about 0.4 mm to 1.0 mm. This makes it difficult to reduce the overall thickness of the display device. When a transparent conductive layer-attached film is used as a shielding layer, it is necessary not only to provide a film base that supports a transparent conductive layer, but also to stack sticky layers for bonding between the transparent conductive layer-attached film and the touch panel and between the transparent conductive layer-attached film and the display panel. This is disadvantageous in reducing the thickness of the display device.

In the display device disclosed in Japanese Unexamined Patent Application Publication No. 2010-86498, a transparent conductive layer serving as a shield against electromagnetic noise is formed by a thin-film method, such as sputtering. Therefore, it is necessary to carry out a double-sided film deposition step which involves depositing an electrode layer for detecting input position information on one surface of a transparent base, and depositing a transparent conductive layer serving as a shielding layer on the other surface of the transparent base. The double-sided film deposition step requires expensive manufacturing facilities, adds complexity to the manufacturing process, and increases the manufacturing costs. When a transparent conductive layer is formed by a thin-film method, it is desirable to improve the crystallinity of the transparent conductive layer by applying a heat treatment of at least 200° C., preferably 450° C., thereto to enhance the shielding effect. Addition of this heat-treatment step further increases the manufacturing costs. Moreover, since a transparent base for a touch panel needs to be highly heat resistant, materials that can be used for forming the transparent base are limited. This leads to an increase in material costs.

The present invention solves the problems described above, and provides a touch panel integrated display device and a method for manufacturing the same that can suppress electromagnetic noise from a display panel, reduce the device thickness, and lower the manufacturing costs.

### SUMMARY OF THE INVENTION

A touch panel integrated display device according to an aspect of the present invention includes a display panel, a touch panel configured to detect input position information, and a light-transmissive sticky layer configured to bond the display panel to the touch panel. A transparent conductive layer is formed on a display surface of the display panel, with an adhesive layer interposed therebetween. The adhesive layer and the transparent conductive layer are formed by transfer onto the display surface. The transparent conductive layer and the touch panel are bonded to each other, with the sticky layer interposed therebetween.

By forming the transparent conductive layer on the display surface of the display panel, it is possible to block electromagnetic noise from the display panel and prevent degradation of the S/N ratio and malfunction of the touch panel. With the transfer method, the transparent conductive layer can be formed with equipment simpler than that used in a thin-film method, such as sputtering or evaporation. It is thus possible to reduce the manufacturing costs. Moreover, since there is no need to carry out a cumbersome step, such as a double-sided film deposition step, it is possible to simplify the manufacturing process, reduce the manufacturing time, and achieve higher productivity.

The transparent conductive layer is formed by transfer onto the display surface of the display panel, with the adhesive layer interposed therebetween. The touch panel and the transparent conductive layer are bonded to each other, with the sticky layer interposed therebetween. That is, the touch panel and the display panel are integrally stacked, without any space therebetween. The adhesive layer transferred together with the transparent conductive layer is as thin as several micrometers. Moreover, since there is no need to provide a film or the like for supporting the transparent conductive layer, it is possible to reduce the thickness of the touch panel integrated display device. Additionally, since the thickness of the transferred adhesive layer is small, a significant reduction in light transmittance can be avoided.

Thus, according to the aspect of the present invention, it is possible to provide a touch panel integrated display device that can suppress electromagnetic noise from the display panel, reduce the device thickness, avoid a significant reduction in light transmittance, and lower the manufacturing costs.

In the touch panel integrated display device according to the aspect of the present invention, a polarizing layer may be stacked on an input surface of the touch panel.

In the touch panel integrated display device according to the aspect of the present invention, a phase changing layer may preferably be formed between the polarizing layer and the display panel, the phase changing layer being configured to change phases of incident light and emitted light. Thus, when light incident from outside is reflected inside the touch panel integrated display device, the amount of reflected light can be reduced by the phase changing layer and the polarizing layer. Since this prevents reflected light from being superimposed on a displayed image on the display panel, the operator can clearly view the displayed image on the display panel. Additionally, since the thickness of the transferred adhesive layer is small, a significant reduction in light transmittance can be avoided even with the phase changing layer.

In the touch panel integrated display device according to the aspect of the present invention, a λ/4 phase retardation layer may preferably be formed between the touch panel and the polarizing layer. Thus, light incident from outside is converted to linear polarization and circular polarization by the polarizing layer and the λ/4 phase retardation layer. This makes it possible to reduce the amount of reflected light. Additionally, since the thickness of the transferred adhesive layer is small, a significant reduction in light transmittance can be avoided even with the λ/4 phase retardation layer.

The touch panel may preferably include a pair of transparent bases and electrode layers stacked on the respective transparent bases, and at least one of the transparent bases may preferably be formed by the λ/4 phase retardation layer. When the transparent base and the λ/4 phase retardation layer of the touch panel are formed by a common member, it is possible to reduce the thickness of the touch panel integrated display device and avoid a significant reduction in light transmittance. Also, the amount of reflected light can be reduced by the polarizing layer and the λ/4 phase retardation layer.

Alternatively, the touch panel may include a transparent base and an electrode layer stacked on one surface of the transparent base, and the transparent base may be formed by the λ/4 phase retardation layer.

In the touch panel integrated display device according to the aspect of the present invention, the adhesive layer may preferably be an ultraviolet-curable resin layer. Thus, since the step of curing and drying the adhesive layer is easy and can be completed in a short time, the manufacturing costs can be reduced.

A method for manufacturing a touch panel integrated display device including a touch panel and a display panel that are integrally stacked, with a light-transmissive sticky layer interposed therebetween, according to another aspect of the present invention includes the steps of (a) forming a transparent conductive layer by transfer onto a display surface of the display panel, with an adhesive layer interposed therebetween, by using a transferable film having the adhesive layer and the transparent conductive layer; and (b) bonding the transparent conductive layer formed on the display surface of the display panel to the touch panel, with the sticky layer interposed therebetween.

In the method for manufacturing the touch panel integrated display device according to the aspect of the present invention, where the transparent conductive layer is formed on the display surface of the display panel, it is possible to block electromagnetic noise from the display panel and prevent degradation of the S/N ratio and malfunction of the touch panel. With the transfer method, the transparent conductive layer can be formed with equipment simpler than that used in a thin-film method, such as sputtering or evaporation. It is thus possible to reduce the manufacturing costs. Moreover, since there is no need to carry out a cumbersome step, such as a double-sided film deposition step, it is possible to simplify the manufacturing process, reduce the manufacturing time, and achieve higher productivity.

The transparent conductive layer is formed by transfer onto the display surface of the display panel, with the adhesive layer interposed therebetween. The touch panel and the transparent conductive layer are bonded to each other, with the sticky layer interposed therebetween. That is, the touch panel and the display panel are integrally stacked, without any space therebetween. The adhesive layer transferred together with the transparent conductive layer is as thin as several micrometers. Moreover, since there is no need to provide a film or the like for supporting the transparent conductive layer, it is possible to reduce the thickness of the touch panel integrated display device. Additionally, since the thickness of the transferred adhesive layer is small, a significant reduction in light transmittance can be avoided.

Thus, according to the aspect of the present invention, it is possible to provide a method for manufacturing a touch panel integrated display device that can suppress electromagnetic noise from the display panel, realize a reduction in device thickness, avoid a significant reduction in light transmittance, and reduce the manufacturing costs.

The method for manufacturing the touch panel integrated display device according to the aspect of the present invention may further include the step of (a′) stacking a polarizing layer on one surface of the touch panel between the step of (a) and the step of (b), the one surface being an input surface of the touch panel.

In this case, the method for manufacturing the touch panel integrated display device according to the aspect of the present invention may preferably further include the step of forming a phase changing layer between the polarizing layer and the display panel, the phase changing layer being configured to change phases of incident light and emitted light. Thus, when light incident from outside is reflected inside the touch panel integrated display device, the amount of reflected light can be reduced by the phase changing layer and the polarizing layer. Since this prevents reflected light from being superimposed on a displayed image on the display panel, the operator can clearly view the displayed image on the display panel. Additionally, since the thickness of the transferred adhesive layer is small, a significant reduction in light transmittance can be avoided even with the phase changing layer.

The step of (a′) may preferably include the step of forming a λ/4 phase retardation layer between the touch panel and the polarizing layer. Thus, light incident from outside is converted to linear polarization and circular polarization by the polarizing layer and the λ/4 phase retardation layer. The circular polarization is internally reflected, propagates as reversed (or 90-degree phase-shifted) circular polarization, and is converted to linear polarization as it passes through the λ/4 phase retardation layer. Since the linear polarization is absorbed without passing through the polarizing layer, it is possible to reduce emission of reflected light to the outside. Additionally, since the thickness of the transferred adhesive layer is small, a significant reduction in light transmittance can be avoided even with the λ/4 phase retardation layer.

The touch panel may preferably include a pair of transparent bases, and electrode layers may be formed on the respective transparent bases. At least one of the transparent bases may preferably be formed by the λ/4 phase retardation layer. When the transparent base and the λ/4 phase retardation layer of the touch panel are formed by a common member, it is possible to reduce the thickness of the touch panel integrated display device and avoid a significant reduction in light transmittance. Also, the amount of reflected light can be reduced by the polarizing layer and the λ/4 phase retardation layer.

Alternatively, the touch panel may include a transparent base and an electrode layer stacked on one surface of the transparent base, and the transparent base may be formed by the λ/4 phase retardation layer.

In the step of (a), the adhesive layer may preferably be an ultraviolet-curable resin layer. Thus, since the step of curing and drying the adhesive layer is easy and can be completed in a short time, the manufacturing costs can be reduced.

### BRIEF DESCRIPTION OF THE DRAWINGS

FIG. 1 is a cross-sectional view of a touch panel integrated display device according to a first embodiment;

FIG. 2 is an exploded perspective view of the touch panel integrated display device according to the first embodiment;

FIG. 3 is a cross-sectional view of a touch panel integrated display device according to a first modification of the first embodiment;

FIG. 4 is a cross-sectional view of a touch panel integrated display device according to a second modification of the first embodiment;

FIG. 5 is a cross-sectional view of a touch panel integrated display device according to a second embodiment;

FIG. 6 is a cross-sectional view of a touch panel integrated display device according to a modification of the second embodiment;

FIG. 7 is a cross-sectional view of a touch panel integrated display device according to a third embodiment;

FIG. 8 is an exploded perspective view of the touch panel integrated display device according to the third embodiment;

FIG. 9 is a plan view of a touch panel included in the touch panel integrated display device according to the third embodiment;

FIG. 10 is an enlarged cross-sectional view taken along line X-X of FIG. 9;

FIG. 11 is a cross-sectional view of a touch panel integrated display device according to a first modification of the third embodiment;

FIG. 12 is a cross-sectional view of a touch panel integrated display device according to a second modification of the third embodiment;

FIG. 13 is a cross-sectional view of a touch panel integrated display device according to a third modification of the third embodiment;

FIG. 14 is a cross-sectional view of a touch panel integrated display device according to a fourth embodiment;

FIG. 15 is a cross-sectional view of a touch panel integrated display device according to a first modification of the fourth embodiment;

FIG. 16 is a cross-sectional view of a touch panel integrated display device according to a second modification of the fourth embodiment;

FIG. 17A to FIG. 17D illustrate a series of steps involved in a method for manufacturing a touch panel integrated display device according to an embodiment of the present invention;

FIG. 18 is a cross-sectional view of a transferable transparent conductive film; and

FIG. 19 is a cross-sectional view of a touch panel integrated display device according to the related art.

### DESCRIPTION OF THE PREFERRED EMBODIMENTS

### First Embodiment

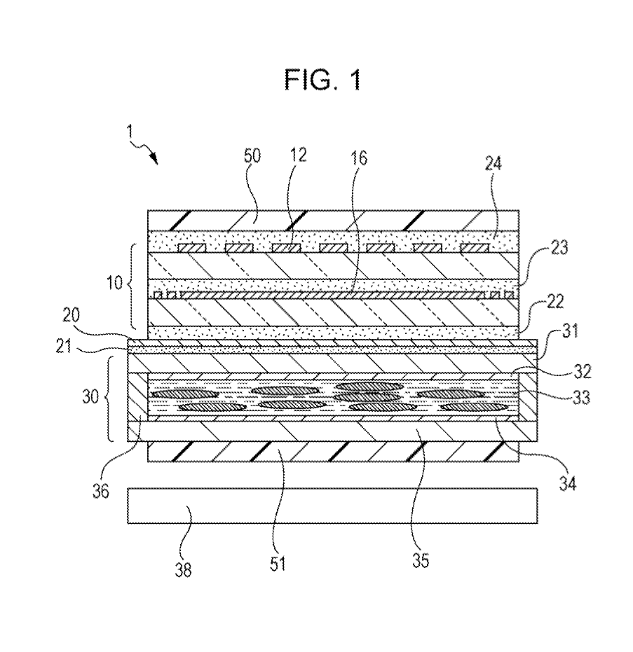

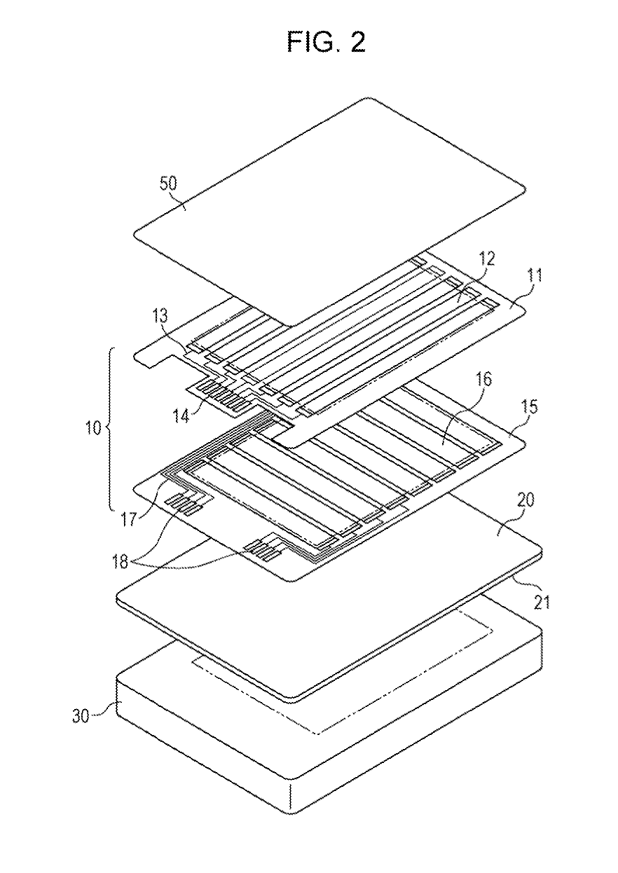

FIG. 1 is a cross-sectional view of a touch panel integrated display device 1 according to a first embodiment. FIG. 2 is an exploded perspective view of the touch panel integrated display device 1. Note that dimensions in each drawing are changed as necessary for visibility.

As illustrated in FIG. 1, in the touch panel integrated display device 1 of the present embodiment, a liquid crystal panel 30 is used as a display panel that displays images and text information. A capacitive touch panel 10 serving as a light-transmissive touch panel is disposed on a display side of the liquid crystal panel 30. Through the touch panel 10, the operator can view images from the liquid crystal panel 30. The operator can thus perform an input operation on the touch panel 10 while viewing displayed images and menus.

A transparent conductive layer 20 is formed by transfer onto the display surface of the liquid crystal panel 30, with an adhesive layer 21 interposed therebetween. The transparent conductive layer 20 serves as a shield against electromagnetic noise from the liquid crystal panel 30. A surface of the transparent conductive layer 20 is bonded to the touch panel 10, with a sticky layer 22 interposed therebetween. Thus, the touch panel 10 and the liquid crystal panel 30 are integrally bonded to each other to form the touch panel integrated display device 1.

As illustrated in FIG. 2, the touch panel 10 for detection of input position information may include a first transparent base 11 and a second transparent base 15 that face each other. For visibility of the drawing, sticky layers between adjacent layers are omitted in FIG. 2. A first electrode layer 12 may be formed on the first transparent base 11, and a second electrode layer 16 may be formed on the second transparent base 15. The first electrode layer 12 and the second electrode layer 16 extend in directions intersecting each other. The first electrode layer 12 and the second electrode layer 16 are stacked to form capacitances at their intersections.

A first connecting portion 14 and a second connecting portion 18 for connection to a flexible printed wiring board (not shown) are formed on the first transparent base 11 and the second transparent base 15, respectively. The first electrode layer 12 and the first connecting portion 14 are electrically connected to each other by a first lead electrode layer 13. The second electrode layer 16 and the second connecting portion 18 are electrically connected to each other by a second lead electrode layer 17.

By touching an input surface with a finger or the like in an input operation on the touch panel 10, a capacitance between the finger and the first electrode layer 12 is added to the capacitance between the first electrode layer 12 and the second electrode layer 16 and hence there is a change in capacitance. Information about the change in capacitance is output through the first lead electrode layer 13 and the second lead electrode layer 17 to an external circuit. Then, the input position is identified on the basis of the change in capacitance.

The first transparent base 11 and the second transparent base 15 are made of flexible film material and have a thickness of about 50 μm to 200 μm. For example, the first transparent base 11 and the second transparent base 15 may be polyethylene terephthalate (PET) films.

The first electrode layer 12 and the second electrode layer 16 are formed by sputtering or evaporating a transparent conductive material, such as indium tin oxide (ITO), SnO2, or ZnO, having light transmittance in the visible light range. The first electrode layer 12 and the second electrode layer 16 are about 0.01 μm to 0.05 μm, for example, about 0.02 μm in thickness. The first electrode layer 12 and the second electrode layer 16 may be formed by techniques other than sputtering or evaporation. For example, a film having a transparent conductive film formed thereon may be prepared in advance and only the transparent conductive film may be transferred to a base to form an electrode layer thereon, or a liquid material may be applied to a base to form an electrode layer thereon.

As illustrated in FIG. 1, the liquid crystal panel 30 is used as a display panel in the touch panel integrated display device 1 of the present embodiment. A first polarizing layer 50 may be disposed on the input side of the touch panel 10, and a second polarizing layer 51 may be disposed on a lower side of the liquid crystal panel 30. A backlight 38 serving as a light source is disposed below the second polarizing layer 51. The first polarizing layer 50 and the second polarizing layer 51 each include a resin film formed by stretching, in one direction, polyvinyl alcohol (PVA) resin in which iodine or dye is adsorbed. Protective films made of triacetylacetate (TAC) are stacked on both sides of the resin film.

The first polarizing layer 50 and the second polarizing layer 51 are configured to allow passage of only light having an amplitude in a predetermined direction. Light is converted to linear polarization as it passes through the first polarizing layer 50 or the second polarizing layer 51. Light incident from the backlight 38 onto the second polarizing layer 51 is converted to linear polarization and is incident on a liquid crystal layer 33. The light incident on the liquid crystal layer 33 propagates across the thickness of the liquid crystal layer 33 while changing the direction of polarization depending on the orientation of liquid crystal molecules or without changing the direction of polarization. After passing through the liquid crystal layer 33, the light is incident on the first polarizing layer 50. Only light having the direction of polarization of the first polarizing layer 50 is passed therethrough and output as a display image.

As illustrated in FIG. 1, the liquid crystal panel 30 includes the liquid crystal layer 33 interposed between an upper substrate 31 and a lower substrate 35. The upper substrate 31 and the lower substrate 35 are spaced apart by a predetermined distance defined by a spacer 36. The upper substrate 31 is a color filer substrate having a colored layer (not shown) formed on one surface thereof. The colored layer includes red (R), green (G), and blue (B) elements regularly arranged. An upper electrode (counter electrode) 32 and a lower electrode (pixel electrode) 34 are formed on opposite surfaces of the upper substrate 31 and the lower substrate 35, respectively. By applying a voltage between the upper electrode 32 and the lower electrode 34, the orientation of liquid crystal molecules forming the liquid crystal layer 33 can be changed.

By applying a voltage to the liquid crystal layer 33, the liquid crystal panel 30 can appropriately control the orientation of liquid crystal molecules, change the direction of polarization of light passing through the liquid crystal layer 33, and thus display a desired image.

A voltage applied to control the liquid crystal layer 33 causes electromagnetic noise to be radiated to the outside. If the electromagnetic noise is superimposed on the first electrode layer 12 and the second electrode layer 16 of the touch panel 10, or on an output signal from the first lead electrode layer 13 and the second lead electrode layer 17, the electromagnetic noise may become background noise and degrade the S/N ratio, or even cause malfunction of the touch panel 10.

In the touch panel integrated display device 1 of the present embodiment, the transparent conductive layer 20 is stacked on the display surface of the liquid crystal panel 30, with the adhesive layer 21 interposed therebetween. The transparent conductive layer 20 is made of transparent conductive material, such as ITO, SnO2, or ZnO, having light transmittance in the visible light range. The transparent conductive layer 20 can block electromagnetic noise from the liquid crystal panel 30 and suppress radiation of the electromagnetic noise to the touch panel 10. It is thus possible to prevent degradation of the S/N ratio and malfunction of the touch panel 10.

The transparent conductive layer 20 is formed by transfer onto the surface of the liquid crystal panel 30 using a transferable transparent conductive film. The transferable transparent conductive film is obtained by integrally forming the transparent conductive layer 20 and the adhesive layer 21 on a film base. The transparent conductive layer 20 and the adhesive layer 21 can be formed to be as thin as several micrometers in total thickness. Since the film base that supports the transparent conductive layer 20 is completely peeled off during the manufacturing process, it is possible to reduce the thickness of the touch panel integrated display device 1.

The adhesive layer 21 may be made of acrylic ultraviolet-curable resin. In this case, since residual stress in the adhesive layer 21 after curing is small, it is possible to prevent occurrence of a problem, such as substrate warpage. Moreover, in the step of forming the transparent conductive layer 20 by transfer, since the step of curing and drying the adhesive layer 21 can be completed in a short time, it is possible to reduce the manufacturing costs. Both ultraviolet-curable resin and thermosetting resin may be used to form the adhesive layer 21.

As illustrated in FIG. 1, the touch panel 10 and the transparent conductive layer 20 are bonded to each other, with the sticky layer 22 interposed therebetween. That is, the touch panel 10 and the transparent conductive layer 20 are integrally stacked, without any space therebetween, to form the touch panel integrated display device 1. The sticky layer 22 may be a light-transmissive acrylic double-faced tape or an acrylic adhesive layer having a thickness of about 50 μm to 100 μm. Thus, even if the touch panel 10 and the liquid crystal panel 30 are integrally bonded to each other, electromagnetic noise from the liquid crystal panel 30 can be blocked by the transparent conductive layer 20.

On the other hand, in the method which involves providing a space between a display panel and a touch panel, it is necessary that the display panel and the touch panel be spaced apart by a distance of about 0.4 mm to 1.0 mm to prevent malfunction caused by electromagnetic noise from the display panel. This makes it difficult to achieve a reduction in device thickness. Additionally, the presence of an air gap between the display panel and the touch panel may cause reflection of external light, and thus is disadvantageous in reducing the amount of reflection.

In the method which involves separately preparing an electromagnetic shielding member, such as a transparent conductive layer-attached film, it is necessary that sticky layers be stacked on both sides of the shielding member which is bonded to the touch panel and the display panel. In this case, due to the increased number of stacked sticky layers as well as the thickness of the film base that supports the transparent conductive layer, it is difficult to reduce the device thickness.

In the touch panel integrated display device 1 of the present embodiment, where the transparent conductive layer 20 is formed by transfer to suppress electromagnetic noise, there is no need to provide a space between the liquid crystal panel 30 and the touch panel 10 to suppress electromagnetic noise interference. Also, there is no need to provide a shielding member, such as a transparent conductive layer-attached film. It is thus possible to reduce the thickness of the touch panel integrated display device 1.

Forming a transparent conductive layer by a thin-film method, such as sputtering or evaporation, as disclosed in Japanese Unexamined Patent Application Publication No. 2010-86498 involves use of expensive vacuum equipment. Moreover, to enhance the shielding effect, it is desirable to apply a heat treatment of at least 200° C., preferably 450° C., to improve the crystallinity of the transparent conductive layer. Addition of this heat-treatment step increases the time and costs involved in manufacture. To form a transparent conductive layer by a thin-film method, it is necessary to carry out a double-sided film deposition step. The double-sided film deposition step involves depositing an electrode layer on one surface of a transparent base of a touch panel, and depositing a transparent conductive layer serving as a shielding layer on the other surface of the transparent base. Simultaneous deposition of these layers requires not only vacuum equipment having a complex mechanism, but also expensive facilities. Separate deposition of these layers increases the number of steps involved in the manufacturing process and leads to an increase in manufacturing costs. Depositing a transparent conductive layer on an upper substrate of a liquid crystal panel, not on the touch panel, also requires a double-sided film deposition step and thus suffers similar problems. The double-sided film deposition makes the manufacturing process cumbersome and makes it difficult to ensure reproducibility of film properties.

In the present embodiment, where a transferable transparent conductive film is used, the transparent conductive layer 20 can be formed by transfer onto the liquid crystal panel 30, with the adhesive layer 21 interposed therebetween. Thus, since the transparent conductive layer 20 can be formed with simple equipment and there is no need to carry out a vacuum step, the time and costs involved in manufacture can be reduced. Moreover, since the transfer step does not require heat treatment, it is easy to realize reproducibility of film properties of the transparent conductive layer 20.

The touch panel integrated display device 1 of the present embodiment thus can suppress electromagnetic noise from the liquid crystal panel 30, reduce the device thickness, and lower the manufacturing costs. In the present embodiment, the transparent conductive layer 20 is formed by transfer onto the surface of the liquid crystal panel 30. The same effect can be achieved when the transparent conductive layer 20 is formed on the surface of the touch panel 10 facing the liquid crystal panel 30.

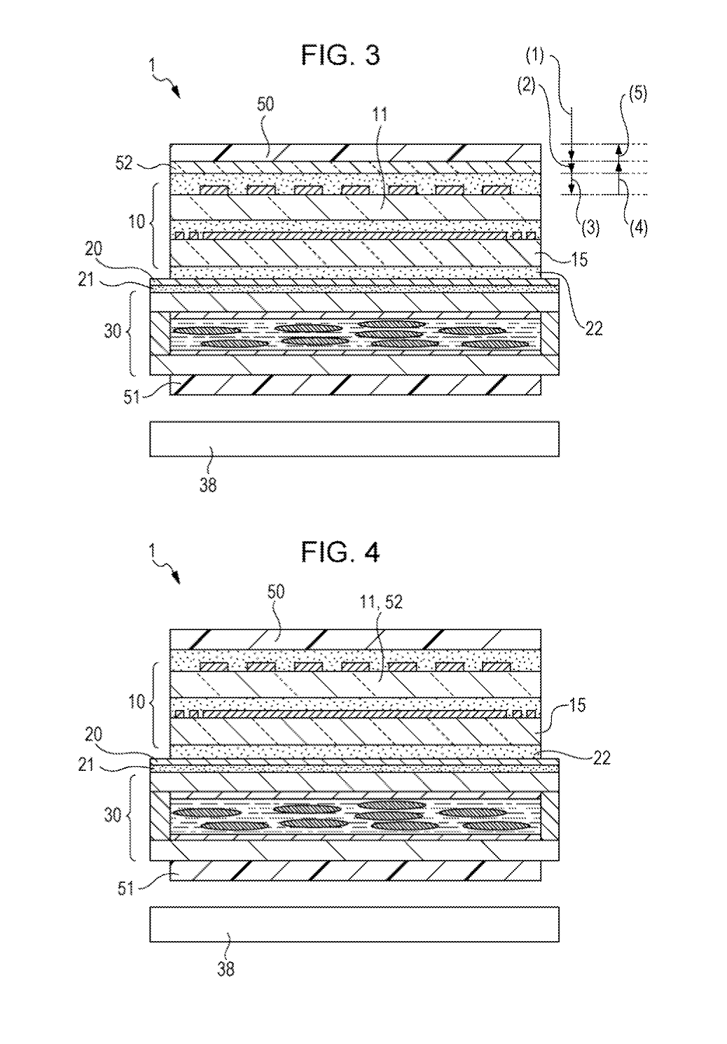

FIG. 3 is a cross-sectional view of a touch panel integrated display device 1 according to a first modification of the first embodiment. In the present modification, a λ/4 phase retardation layer 52 may be disposed between the first polarizing layer 50 and the touch panel 10. The λ/4 phase retardation layer 52 serves as a phase changing layer for changing phases of incident light and emitted light. The λ/4 phase retardation layer 52 is made of light-transmissive resin, such as cyclic olefin copolymer (COP) or polycarbonate (PC). Although not shown in FIG. 3, the first polarizing layer 50 and the λ/4 phase retardation layer 52 are bonded to each other, with a sticky layer interposed therebetween.

Light incident on the λ/4 phase retardation layer 52 is divided by double refraction into two orthogonal linear polarization components, to which a ¼ wavelength phase shift is given. In the present modification, the λ/4 phase retardation layer 52 is positioned such that its optical axis forms an angle of 45 degrees or 135 degrees with the transmission axis of the first polarizing layer 50.

As illustrated in FIG. 3, light (1) incident from outside is converted to linear polarization (2) as it passes through the first polarizing layer 50. The linear polarization (2) is converted to circular polarization (3) as it passes through the λ/4 phase retardation layer 52. After passing through the λ/4 phase retardation layer 52, the light is reflected by an interface between stacked members, such as the first transparent base 11 and the second transparent base 15, or between electrode layers, and propagates as circular polarization (4) rotating in a direction opposite the rotation direction of the circular polarization (3). That is, the circular polarization (4) is phase-shifted 90 degrees from the circular polarization (3). The circular polarization (4) is converted to linear polarization (5) as it passes through the λ/4 phase retardation layer 52. Since the optical axis of the linear polarization (5) and the transmission axis of the first polarizing layer 50 are different in phase by 90 degrees, the linear polarization (5) is absorbed in the first polarizing layer 50. Thus, the first polarizing layer 50 and the λ/4 phase retardation layer 52 suppress emission of reflected light to the outside.

In the present modification, light incident from outside and reflected inside the touch panel integrated display device 1 can be prevented from returning to the outside. Therefore, even if the touch panel integrated display device 1 is used in a place where there is much extraneous light, such as the outdoors, reflected light can be prevented from being superimposed on display light of the liquid crystal panel 30. The operator thus can clearly view the displayed image on the liquid crystal panel 30.

As illustrated, the touch panel 10 and the liquid crystal panel 30 are stacked without any space therebetween, so that the thickness of the stacked members can be reduced. It is thus possible to reduce transmission loss of display light from the backlight 38, and allow the operator to clearly view the displayed image.

The λ/4 phase retardation layer 52 is formed between the first polarizing layer 50 and the liquid crystal panel 30 in the present modification, but this is not to be considered limiting. For example, a lower λ/4 phase retardation layer (not shown) may be added between the touch panel 10 and the liquid crystal panel 30. In this case, light emitted from the backlight 38 is converted to linear polarization as it passes through the second polarizing layer 51. The linear polarization is converted to circular polarization as it passes through the lower λ/4 phase retardation layer. The circular polarization is converted to linear polarization as it passes through an upper λ/4 phase retardation layer (λ/4 phase retardation layer 52). The linear polarization passes through the first polarizing layer 50 and is emitted outside. It is thus possible to minimize loss of display light from the backlight 38 for displaying an image. Here, the direction of the transmission axis of the first polarizing layer 50 coincides with that of the transmission axis of the second polarizing layer 51.

FIG. 4 is a cross-sectional view of a touch panel integrated display device 1 according to a second modification of the first embodiment.

As illustrated in FIG. 4, in the second modification, the first transparent base 11 may be constituted by the λ/4 phase retardation layer 52. The first transparent base 11 (λ/4 phase retardation layer 52) may be a film of light-transmissive resin, such as COP or PC. In this case, it is preferable that an optically isotropic resin film be used as the second transparent base 15.

In the present modification, where the first transparent base 11 and the λ/4 phase retardation layer 52 are constituted by a common member, it is possible to add a λ/4 phase changing function without increasing the number of stacked layers. As in the first modification, light incident from outside is converted to circular polarization as it passes through the first transparent base 11 (λ/4 phase retardation layer 52). After reflected by an interface of the second transparent base 15 or the transparent conductive layer 20, the light propagates as reversed (or 90-degree phase-shifted) circular polarization. The reflected light is converted to linear polarization as it passes through the first transparent base 11 (λ/4 phase retardation layer 52), and is absorbed by the first polarizing layer 50. Thus, in the present modification, it is possible not only to reduce the device thickness, but also to reduce the amount of reflected light.

The λ/4 phase retardation layer 52 may be used to form both the first transparent base 11 and the second transparent base 15. In this case, it is possible to suppress reflection of external light, and minimize loss of display light from the backlight 38 for displaying an image.

### Second Embodiment

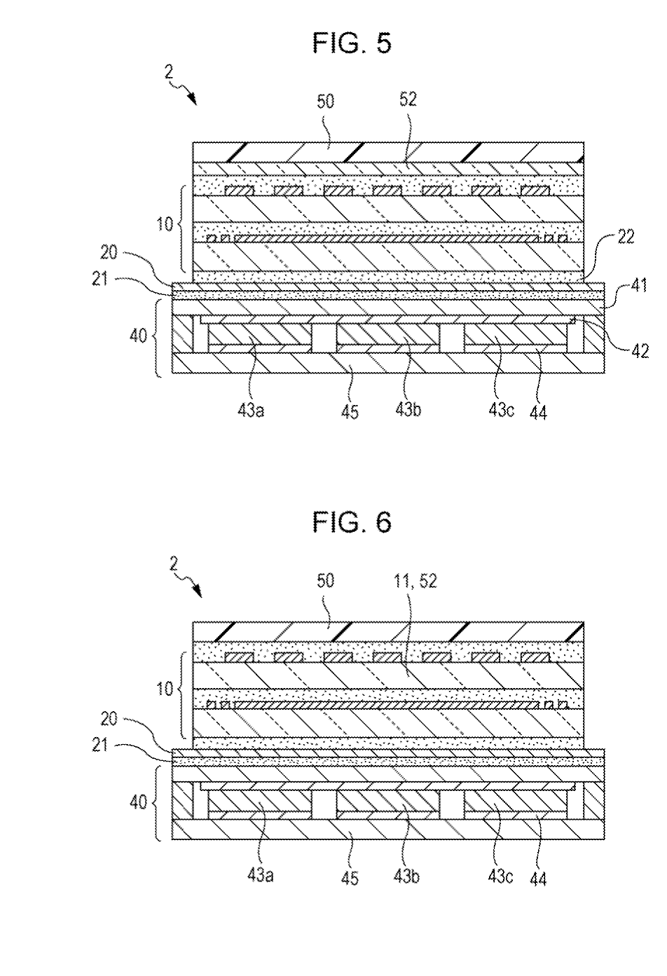

FIG. 5 is a cross-sectional view of a touch panel integrated display device 2 according to a second embodiment. The same components as those of the first embodiment are given the same reference numerals.

In the present embodiment, an OLED panel 40 is used as a display panel that displays images and text information. The transparent conductive layer 20 for suppressing electromagnetic noise is formed by transfer onto the display surface of the OLED panel 40, with the adhesive layer 21 interposed therebetween. The touch panel 10 is bonded to the transparent conductive layer 20, with the sticky layer 22 interposed therebetween.

The OLED panel 40 includes a plurality of light-emitting function layers 43, each formed by stacking a positive-hole transport layer, a light emitting layer, and an electron injection layer (not shown). The light-emitting function layers 43 include light-emitting function layers 43a that emit red light, light-emitting function layers 43b that emit green light, and light-emitting function layers 43c that emit blue light. The light-emitting function layers 43a to 43c (only partially shown in FIG. 5) are arranged in large numbers in a matrix in plan view. The light-emitting function layers 43 are interposed between an upper electrode (common electrode) 42 and a lower electrode (pixel electrode) 44. Applying a voltage between the upper electrode 42 and the lower electrode 44 causes the light-emitting function layers 43 to emit light and display a desired image.

Unlike the liquid crystal panel 30, the OLED panel 40 does not require a backlight, because the light-emitting function layers 43 are capable of emitting light and displaying images. Since the light-emitting function layers 43 are solid and resistant to a certain level of pressure, thin substrates can be used as the upper substrate 41 and the lower substrate 45. Therefore, when the OLED panel 40 is used, it is possible to further reduce the device thickness, as compared to the case where the liquid crystal panel 30 is used. Flexible substrates may be used as the upper substrate 41 and the lower substrate 45. This can add flexibility to the entire OLED panel 40. The OLED panel 40 having flexibility can be used, for example, in equipment that displays images on a curved surface.

In the OLED panel 40, electromagnetic noise produced by a voltage applied between electrodes may also cause degradation of the S/N ratio and malfunction of the touch panel 10. However, in the present embodiment, as illustrated in FIG. 5, the transparent conductive layer 20 is formed by transfer onto the display surface of the OLED panel 40, with the adhesive layer 21 interposed therebetween. The transparent conductive layer 20 can suppress electromagnetic noise from the OLED panel 40 and prevent malfunction of the touch panel 10. In the present embodiment, where the transparent conductive layer 20 is formed by transfer and the touch panel 10 and the OLED panel 40 are integrally stacked, it is possible to reduce the thickness of the touch panel integrated display device 2. Since the transparent conductive layer 20 can be formed by a transfer method using simple equipment in a short time, the manufacturing costs can be reduced.

In the present embodiment, the lower electrode 44 is made of transparent conductive material, such as ITO, and the upper electrode 42 is made of metal material, such as Al or Cr. Therefore, if the upper electrode 42 is viewed from the operator side, the quality of the displayed image may be degraded. As illustrated in FIG. 5, the first polarizing layer 50 and the λ/4 phase retardation layer 52 are stacked on the input side of the touch panel integrated display device 2. This makes it possible to suppress reflection of light incident from outside, prevent reflected light from being superimposed on display light, and prevent the upper electrode 42 from being viewed from the operator side. It is thus possible to prevent degradation of the quality of the displayed image.

FIG. 6 illustrates a modification of the second embodiment. In the present modification, the λ/4 phase retardation layer 52 may be used as the first transparent base 11 of the touch panel 10. This can reduce the thickness of the touch panel integrated display device 2. At the same time, since a phase changing function is added, the amount of reflected light can be reduced. The reduction in device thickness can improve light transmittance, reduce loss of display light from the OLED panel 40, and improve quality of the displayed image.

### Third Embodiment

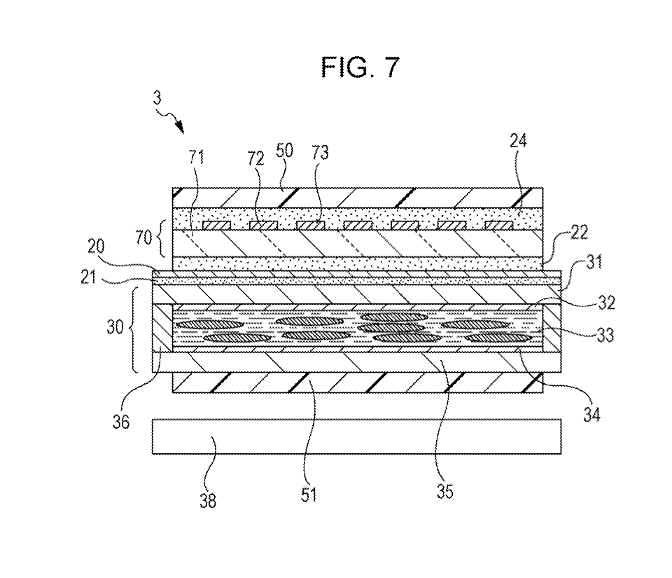

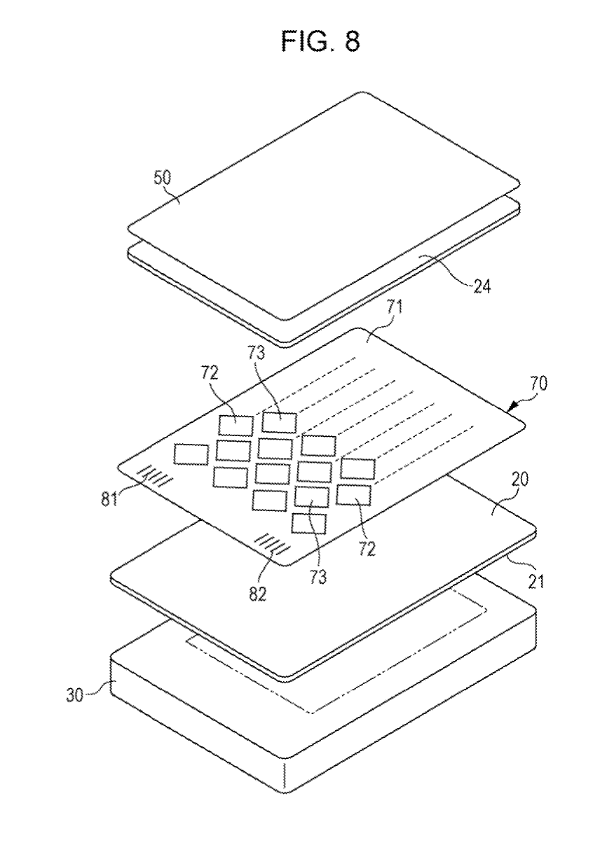

FIG. 7 is a cross-sectional view of a touch panel integrated display device 3 according to a third embodiment. FIG. 8 is an exploded perspective view of the touch panel integrated display device 3.

The touch panel integrated display device 3 illustrated in FIG. 7 includes a touch panel 70, instead of the touch panel 10 of the touch panel integrated display device 1 of the first embodiment illustrated in FIG. 1. Except for the touch panel 70, the structure of the touch panel integrated display device 3 illustrated in FIG. 7 is the same as that of the touch panel integrated display device 1 illustrated in FIG. 1.

The touch panel 70 is formed by arranging first electrode layers 72 and second electrode layers 73 only on an input side of a transparent base 71. The transparent base 71 is made of flexible film material. For example, a PET film is used as the transparent base 71. The first electrode layers 72 and the second electrode layers 73 are made of transparent conductive material, such as ITO, SnO2, or ZnO.

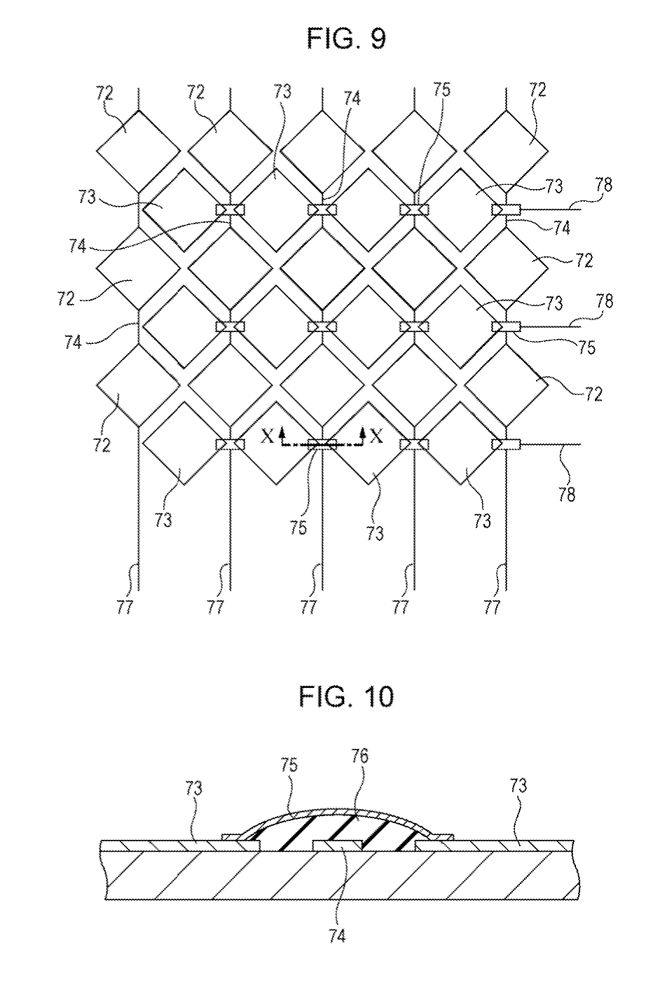

As illustrated in FIG. 8 and FIG. 9, the first electrode layers 72 and the second electrode layers 73 have the same shape and area, and are rectangular or diamond-shaped. The first electrode layers 72 and the second electrode layers 73 are regularly arranged in rows and columns. The first electrode layers 72 are connected by longitudinal-connection electrode layers 74 in a longitudinal direction. The second electrode layers 73 are separate from the first electrode layers 72 and the longitudinal-connection electrode layers 74.

A transparent conductive material, such as ITO, is sputtered or evaporated onto a surface of the transparent base 71, such as a PET film, to form a transparent conductive film having a thickness of 0.01 μm to 0.05 μm. By etching the transparent conductive film on the surface of the transparent base 71, it is possible to simultaneously form the first electrode layers 72, the second electrode layers 73, and the longitudinal-connection electrode layers 74.

As illustrated in FIG. 10, a longitudinal-connection electrode layer 74 passes between second electrode layers 73 laterally adjacent to each other. The surface of the longitudinal-connection electrode layer 74 is covered with an insulating layer 76 made of organic material. The laterally adjacent second electrode layers 73 are electrically connected to each other by a lateral-connection electrode layer 75 formed on the surface of the insulating layer 76. The lateral-connection electrode layer 75 is made of conductive material, such as gold or silver.

As illustrated in FIG. 9, each column of first electrode layers 72 longitudinally connected by a longitudinal-connection electrode layer 74 is connected through a longitudinal lead-electrode layer 77 to a longitudinal connecting portion 81 illustrated in FIG. 8. Each row of second electrode layers 73 laterally connected by lateral-connection electrode layers 75 is connected through a lateral lead-electrode layer 78 to a lateral connecting portion 82 illustrated in FIG. 8.

By touching an input surface with a finger or the like in an input operation on the touch panel 70, a capacitance between the finger and each of the electrode layers 72 and 73 is added to a capacitance between the longitudinally connected first electrode layers 72 and the laterally connected second electrode layers 73 and hence the total capacitance value is changed.

By sequentially applying a voltage to the first electrode layers 72 on a column-by-column basis and measuring current values detected from all first electrode layers 72 in each row, it is possible to determine the column which contains a first electrode layer 72 approached by the finger. Similarly, by applying a voltage to the second electrode layers 73 on a row-by-row basis and measuring current values detected from all second electrode layers 73 in each column, it is possible to determine the row which contains a second electrode layer 73 approached by the finger. This detecting operation makes it possible to identify the coordinates on the surface of the touch panel 70 approached by the finger.

In the touch panel integrated display device 3 illustrated in FIG. 7, the transparent conductive layer 20 is disposed on the display surface of the liquid crystal panel 30, with the adhesive layer 21 interposed therebetween. The transparent conductive layer 20 and the adhesive layer 21 are the same as those used in the touch panel integrated display device 1 illustrated in FIG. 1. By using a transferable transparent conductive film obtained by integrally forming the transparent conductive layer 20 and the adhesive layer 21 on a film base, the transparent conductive layer 20 and the adhesive layer 21 are formed by transferring them onto the surface of the liquid crystal panel 30.

As illustrated in FIG. 7, the touch panel 70 and the transparent conductive layer 20 are bonded to each other, with the sticky layer 22 interposed therebetween. That is, the touch panel 70 and the transparent conductive layer 20 are integrally stacked, without any space therebetween, to form the touch panel integrated display device 3. The first polarizing layer 50 may be disposed on the input side of the touch panel 70, with a sticky layer 24 interposed therebetween. The sticky layer 22, the sticky layer 24, and the first polarizing layer 50 are the same as those used in the touch panel integrated display device 1 illustrated in FIG. 1.

Since the other components of the touch panel integrated display device 3 illustrated in FIG. 7 are the same as those of the touch panel integrated display device 1 illustrated in FIG. 1, the same reference numerals as those in FIG. 1 are given thereto and their detailed description will be omitted.

The transparent conductive layer 20 is made of transparent conductive material, such as ITO, SnO2, or ZnO, having light transmittance in the visible light range. The transparent conductive layer 20 can block electromagnetic noise from the liquid crystal panel 30 and suppress radiation of the electromagnetic noise to the touch panel 70.

In the touch panel 70 illustrated in FIG. 7, the electrode layers 72 and 73 are formed only on the input side of the transparent base 71. Therefore, the liquid crystal panel 30 and the electrode layers 72 and 73 are close in distance to each other. However, the transparent conductive layer 20 extends substantially entirely between the liquid crystal panel 30 and the electrode layers 72 and 73. This makes it easier to block electromagnetic noise from the liquid crystal panel 30 and possible to prevent degradation of the S/N ratio and malfunction of the touch panel 70.

Since the touch panel 70 includes the single transparent base 71 and the electrode layers 72 and 73 formed only on one surface of the transparent base 71, it is possible to reduce the thickness of the touch panel integrated display device 3.

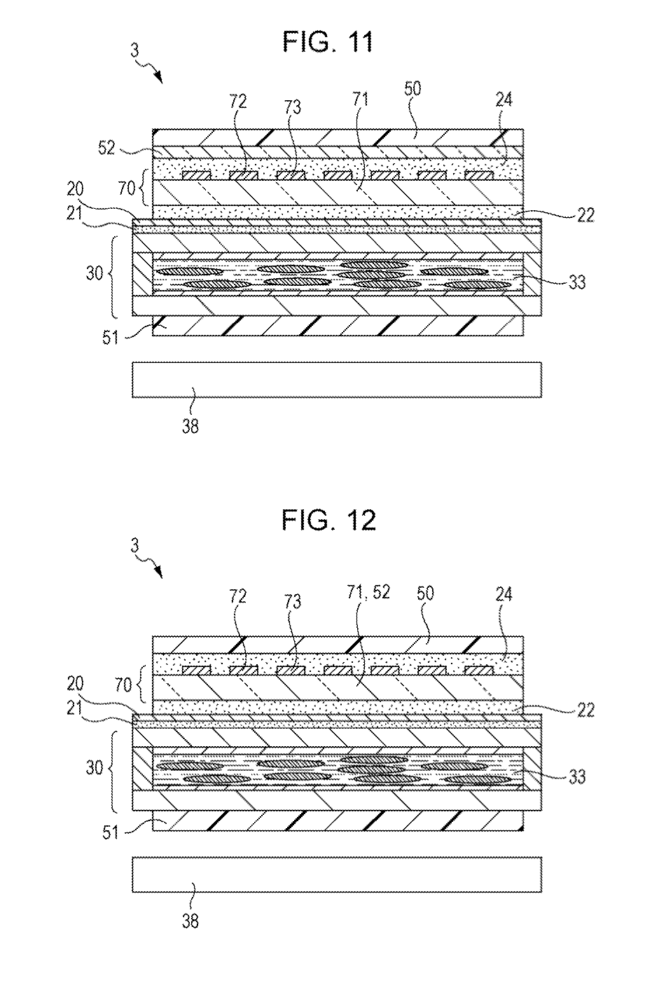

FIG. 11 illustrates a first modification of the third embodiment. A touch panel integrated display device 3 illustrated in FIG. 11 is obtained by replacing the touch panel 10 of the touch panel integrated display device 1 according to the first modification of the first embodiment (see FIG. 3) with the touch panel 70.

The touch panel integrated display device 3 illustrated in FIG. 11 includes the λ/4 phase retardation layer 52 between the first polarizing layer 50 and the touch panel 70. Therefore, even if the touch panel integrated display device 3 is used in a place where there is much extraneous light, such as the outdoors, the operator can clearly view the displayed image.

FIG. 12 illustrates a second modification of the third embodiment. A touch panel integrated display device 3 illustrated in FIG. 12 is obtained by replacing the touch panel 10 of the touch panel integrated display device 1 according to the second modification of the first embodiment (see FIG. 4) with the touch panel 70. In the present modification, the transparent base 71 of the touch panel 70 and the λ/4 phase retardation layer 52 are constituted by a common member.

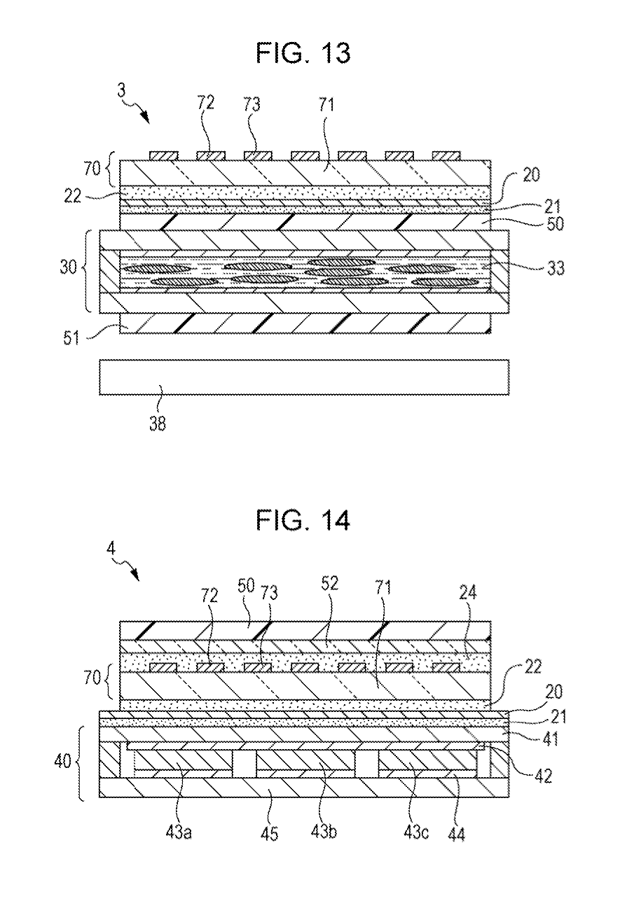

FIG. 13 illustrates a third modification of the third embodiment. In a touch panel integrated display device 3 illustrated in FIG. 13, the first polarizing layer 50 is disposed on the upper surface (display side) of the liquid crystal panel 30, and the second polarizing layer 51 is disposed on the lower surface of the liquid crystal panel 30. Light incident from the backlight 38 onto the second polarizing layer 51 is converted to linear polarization and is incident on the liquid crystal layer 33. The light incident on the liquid crystal layer 33 propagates across the thickness of the liquid crystal layer 33 while changing the direction of polarization depending on the orientation of liquid crystal molecules or without changing the direction of polarization. After passing through the liquid crystal layer 33, the light is incident on the first polarizing layer 50. Only light having the direction of polarization of the first polarizing layer 50 is passed therethrough and output as a display image.

As described above, the first polarizing layer 50 performs part of the display operation of the liquid crystal panel 30. The transparent conductive layer 20 is formed by transfer onto a surface of the first polarizing layer 50, with the adhesive layer 21 interposed therebetween.

The transparent base 71 of the touch panel 70 is bonded to a surface of the transparent conductive layer 20, with the sticky layer 22 interposed therebetween. A surface of the touch panel 70 is provided with a cover layer.

### Fourth Embodiment

FIG. 14 illustrates a touch panel integrated display device 4 according to a fourth embodiment. The touch panel integrated display device 4 illustrated in FIG. 14 is obtained by replacing the touch panel 10 of the touch panel integrated display device 2 according to the second embodiment (see FIG. 5) with the touch panel 70. Except for the touch panel 70, the configuration of the touch panel integrated display device 4 illustrated in FIG. 14 is the same as that of the touch panel integrated display device 2 illustrated in FIG. 5.

In the touch panel integrated display device 4 of the fourth embodiment, the OLED panel 40 is used as a display panel. The touch panel 70 includes the transparent base 71 and the electrode layers 72 and 73 formed on one surface of the transparent base 71. Therefore, the overall thickness of the touch panel 70 is small, and the OLED panel 40 and the electrode layers 72 and 73 are close in distance to each other. However, since the transparent conductive layer 20 extends substantially entirely between the OLED panel 40 and the electrode layers 72 and 73, noise from the OLED panel 40 is less likely to affect the touch panel 70.

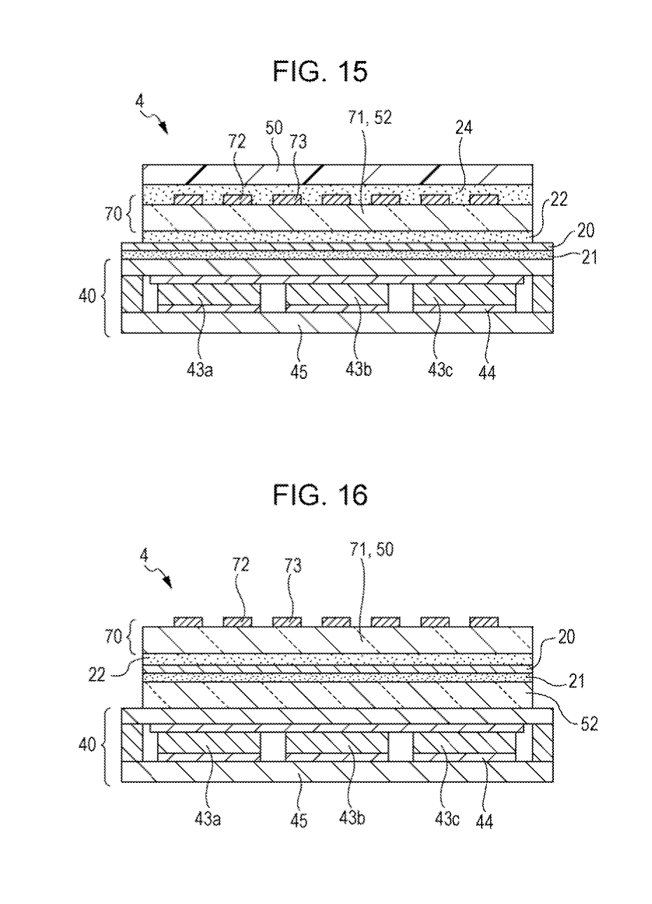

FIG. 15 illustrates a first modification of the fourth embodiment. A touch panel integrated display device 4 illustrated in FIG. 15 is obtained by replacing the touch panel 10 of the touch panel integrated display device 2 according to the modification of the second embodiment (see FIG. 6) with the touch panel 70. Except for the touch panel 70, the structure of the touch panel integrated display device 4 illustrated in FIG. 15 is the same as that of the touch panel integrated display device 2 illustrated in FIG. 6.

FIG. 16 illustrates a second modification of the fourth embodiment. In a touch panel integrated display device 4 illustrated in FIG. 16, the λ/4 phase retardation layer 52 is disposed on the upper surface (display side) of the OLED panel 40. The transparent conductive layer 20 is formed by transfer onto the upper surface of the λ/4 phase retardation layer 52, with the adhesive layer 21 interposed therebetween.

The transparent base 71 of the touch panel 70 is bonded to a surface of the transparent conductive layer 20, with the sticky layer 22 interposed therebetween. The transparent base 71 also serves as the first polarizing layer 50. A surface of the touch panel 70 is provided with a cover layer.

In the second modification of the fourth embodiment, it is possible not only to reduce the thickness of the touch panel integrated display device 4, but also to reduce the amount of reflected light since a phase changing function is added.

### Method for Manufacturing Touch Panel Integrated Display Device

A method for manufacturing the touch panel integrated display device 1 according to an embodiment of the present invention will be described with reference to the drawings.

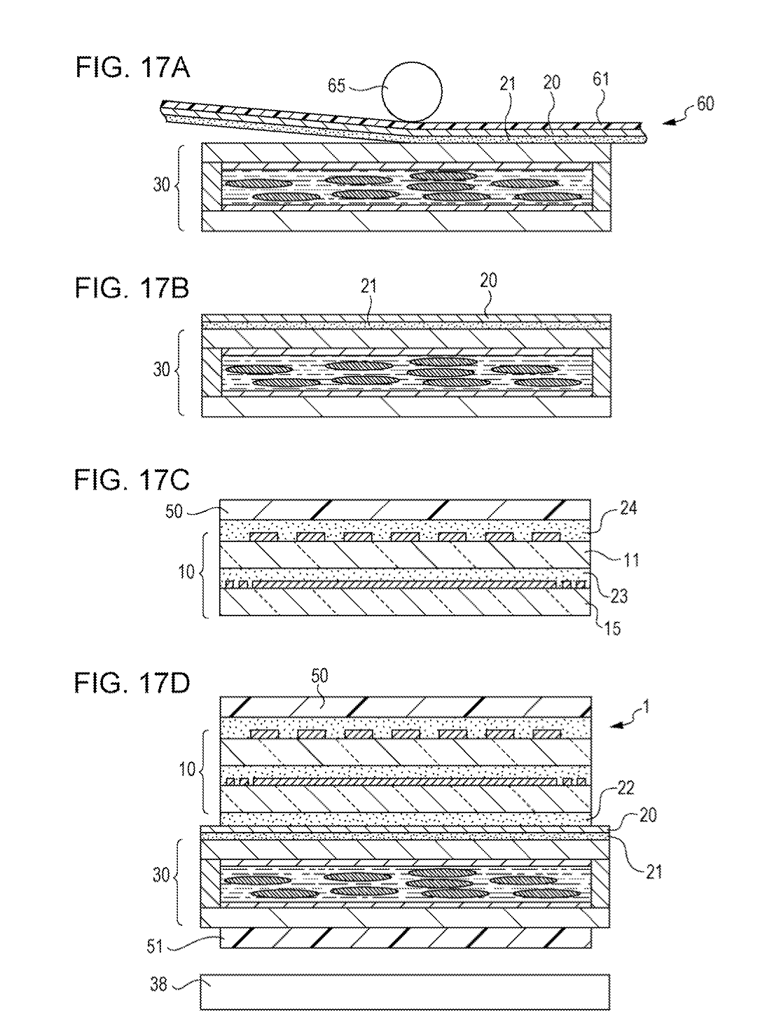

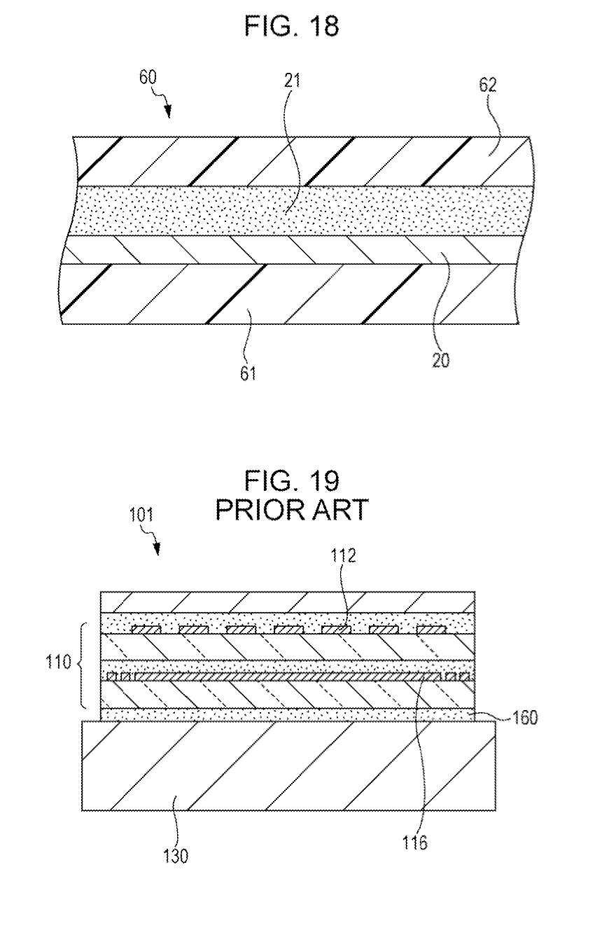

In the step illustrated in FIG. 17A, the adhesive layer 21 and the transparent conductive layer 20 are formed by transfer onto the display surface of the liquid crystal panel 30 by using a transferable transparent conductive film 60. For example, the transferable transparent conductive film 60 illustrated in FIG. 18 can be used here. As illustrated in FIG. 18, the transferable transparent conductive film 60 has a configuration in which the transparent conductive layer 20 and the adhesive layer 21 are interposed between a supporting base 61 and a cover film 62.

The supporting base 61 and the cover film 62 are resin films, such as PET films. The adhesive layer 21 may be made of acrylic ultraviolet-curable resin. The transparent conductive layer 20 is made of transparent conductive material, such as ITO. The transparent conductive layer 20 is formed by a thin-film method, such as sputtering or evaporation, or by a coating method. The configuration of the transferable transparent conductive film 60 is not limited to that illustrated in FIG. 18. The transferable transparent conductive film 60 may have any configuration which allows transfer of the transparent conductive layer 20 and the adhesive layer 21. The transparent conductive layer 20 may be provided with a hard coat layer for protecting the surface of the transparent conductive layer 20.

In the step of forming the adhesive layer 21 and the transparent conductive layer 20 by transfer, the cover film 62 of the transferable transparent conductive film 60 is first peeled off to expose the adhesive layer 21. Then, as illustrated in FIG. 17A, the transparent conductive layer 20 and the supporting base 61 are transferred to the display side of the liquid crystal panel 30, with the adhesive layer 21 interposed therebetween. The transferable transparent conductive film 60 is evenly transferred by application of pressure from a transfer roller 65 and heat as necessary.

After the adhesive layer 21 is cured by ultraviolet irradiation, the supporting base 61 is peeled off. Thus, as illustrated in FIG. 17B, the transparent conductive layer 20 is formed by transfer onto the surface of the liquid crystal panel 30, with the adhesive layer 21 interposed therebetween. The transparent conductive layer 20 has a thickness of about 0.5 μm to 2 μm, for example, about 0.7 μm. The adhesive layer 21 has a thickness of about 1 μm to 5 μm, for example, about 2 μm.

As described above, the transparent conductive layer 20 is formed by a transfer method using the transferable transparent conductive film 60. Since the transparent conductive layer 20 can thus be manufactured with simple equipment, the costs of manufacturing the touch panel integrated display device 1 can be reduced. According to the present method of manufacture, it is possible to eliminate the vacuum step, reduce the time of manufacture, and achieve higher productivity. As described above, since the adhesive layer 21 is cured by ultraviolet irradiation, the step of drying and curing can be completed in a short time. Moreover, since the amount of residual stress after the curing is small, it is possible to prevent occurrence of problems, such as warpage of the liquid crystal panel 30 and peeling of the transparent conductive layer 20.

In the step of FIG. 17C, the first polarizing layer 50 is stacked on the input side of the touch panel 10. The touch panel 10 is formed by bonding the first transparent base 11 and the second transparent base 15 to each other, with a sticky layer 23 interposed therebetween. Alternatively, a component formed by integrally bonding the first transparent base 11 and the second transparent base 15 in advance may be prepared. Then, the first polarizing layer 50 is bonded to the input side of the touch panel 10, with the sticky layer 24 of acrylic resin interposed therebetween.

Next, the transparent conductive layer 20 formed by transfer in the step of FIG. 17B and the touch panel 10 having the first polarizing layer 50 stacked thereon in the step of FIG. 17C are bonded to each other, with the sticky layer 22 interposed therebetween. The touch panel integrated display device 1 illustrated in FIG. 17D can be formed through the steps described above.

With the method for manufacturing the touch panel integrated display device 1 described above, where the transparent conductive layer 20 is formed by transfer onto the display surface of the liquid crystal panel 30, it is possible to block electromagnetic noise from the liquid crystal panel 30 and prevent degradation of the S/N ratio and malfunction of the touch panel 10.

The transparent conductive layer 20 is formed by transfer onto the display surface of the liquid crystal panel 30, with the adhesive layer 21 interposed therebetween. The touch panel 10 and the transparent conductive layer 20 are bonded to each other, with the sticky layer 22 interposed therebetween. That is, the touch panel 10 and the liquid crystal panel 30 are integrally stacked, without any space therebetween. The total thickness of the transparent conductive layer 20 and the adhesive layer 21 is as small as about 2 μm to 3 μm, and there is no need to provide a film or the like for supporting the transparent conductive layer 20. It is thus possible to realize a reduction in thickness.

The step illustrated in FIG. 17B may include the step of stacking the λ/4 phase retardation layer 52 between the touch panel 10 and the first polarizing layer 50. Alternatively, a λ/4 phase changing function may be added to at least one of the first transparent base 11 and the second transparent base 15 of the touch panel 10 by using the λ/4 phase retardation layer 52. This can suppress reflection of light from outside and allow a displayed image to be viewed more clearly.

Through the steps of FIG. 17A to FIG. 17D described above, the touch panel integrated display device 1 is manufactured which includes the liquid crystal panel 30 as a display panel. The same effect can be achieved with the OLED panel 40.

When the touch panel 70 illustrated in FIG. 7 to FIG. 16 is used instead of the touch panel 10 illustrated in FIG. 17C and FIG. 17D, the touch panel integrated display device 3 illustrated in FIG. 7, FIG. 11, FIG. 12, and FIG. 13 and the touch panel integrated display device 4 illustrated in FIG. 14, FIG. 15, and FIG. 16 can be manufactured by the same method as that for manufacturing the touch panel integrated display device 1.

1. A touch panel integrated display device comprising:
a display panel having a display surface, the display panel including:
a transparent conductive layer formed on the display surface with an adhesive layer therebetween by transferring the adhesive layer and the transparent conductive layer onto the display surface;
a touch panel configured to detect input position information; and
a light-transmissive sticky layer bonding the display panel to the touch panel such that the transparent conductive layer and the touch panel are bonded each other with the sticky layer interposed therebetween.

2. The touch panel integrated display device according to claim 1, further comprising:
a polarizing layer stacked over an input surface of the touch panel.

3. The touch panel integrated display device according to claim 2, further comprising:
a phase changing layer formed between the polarizing layer and the display panel, the phase changing layer being configured to change phases of incident light and emitted light.

4. The touch panel integrated display device according to claim 2, further comprising:
a λ/4 phase retardation layer formed between the touch panel and the polarizing layer.

5. The touch panel integrated display device according to claim 3, wherein the phase changing layer includes:
a λ/4 phase retardation layer formed between the touch panel and the polarizing layer.

6. The touch panel integrated display device according to claim 2, wherein the touch panel includes a pair of transparent bases and electrode layers laminated on the respective transparent bases; and
at least one of the transparent bases is formed of a λ/4 phase retardation layer.

7. (canceled)

8. The touch panel integrated display device according to claim 2, wherein the touch panel includes a transparent base and an electrode layer stacked on one surface of the transparent base; and
wherein the transparent base is formed of a λ/4 phase retardation layer.

9. (canceled)

10. The touch panel integrated display device according to claim 1, wherein the adhesive layer is an ultraviolet-curable resin layer.

11. A method for manufacturing a touch panel integrated display device including a touch panel and a display panel that are integrally bonded to each other with a light-transmissive sticky layer interposed therebetween, the method comprising:
(a) transferring a transferable film having an adhesive layer and a transparent conductive layer onto a display surface of the display panel such that the transparent conductive layer is formed on the display surface with the adhesive layer interposed therebetween; and
(b) bonding the display panel and the touch panel such that the transparent conductive layer formed on the display surface is bonded to the touch panel with the sticky layer interposed therebetween.

12. The method according to claim 11, further comprising:
(a′) stacking a polarizing layer over an input surface of the touch panel between step (a) and step (b).

13. The method according to claim 12, further comprising:
forming a phase changing layer between the polarizing layer and the display panel, the phase changing layer being configured to change phases of incident light and emitted light.

14. The method according to claim 12, wherein step (a′) includes:
forming a λ/4 phase retardation layer between the touch panel and the polarizing layer.

15. The method according to claim 13, wherein the forming the phase changing layer includes:
forming a λ/4 phase retardation layer between the touch panel and the polarizing layer.

16. The method according to claim 12, wherein the touch panel includes a pair of transparent bases, and electrode layers are formed on the respective transparent bases; and
at least one of the transparent bases is formed of a λ/4 phase retardation layer.

17. The method according to claim 12, further including:
preparing the touch panel by bonding a first transparent base and a second transparent base to each other, and electrode layers being formed on the respective transparent bases,
wherein at least one of the transparent bases is formed of a λ/4 phase retardation layer.

18. The method according to claim 12, wherein the touch panel includes a transparent base and an electrode layer stacked on one surface of the transparent base; and
the transparent base is formed of a λ/4 phase retardation layer.

19. (canceled)

20. The method according to claim 11, wherein in step (a), the adhesive layer is an ultraviolet-curable resin layer.

21. The touch panel integrated display device according to claim 1, wherein the transparent conductive layer suppresses electromagnetic noises from the display panel to enter the touch panel.

22. The touch panel integrated display device according to claim 2, further comprising:
a second polarizing layer provided on a surface of the display panel opposite to the touch panel.
